(19) United States
(12) Patent Application Publication
(10) Pub. No.: US 2023/0409057 A1
(43) Pub. Date: Dec. 21, 2023

(54) TEMPERATURE CONTROL APPARATUS

(71) Applicant: AUTONICS CORPORATION, Busan (KR)

(72) Inventors: Hoon Hak LEE, Gimpo-si (KR); Hyoung Won SEO, Seoul (KR)

(73) Assignee: AUTONICS CORPORATION, Busan (KR)

(21) Appl. No.: 18/209,677

(22) Filed: Jun. 14, 2023

(30) Foreign Application Priority Data
Jun. 15, 2022 (KR) 10-2022-0072670

(51) Int. Cl. G05D 23/22; G01K 13/00

(52) U.S. Cl. CPC G05D 23/22; G01K 13/00

(57) ABSTRACT

A temperature control apparatus includes; a case including an open front surface, a top surface extending from an upper end of the front surface toward a rear side, a bottom surface extending from a lower end of the front surface toward the rear side, left and right side surfaces extending from left and right side ends of the front surface, and a rear surface connecting rear ends of the top surface, the bottom surface, and the left and right side surfaces; a front cover shielding the front surface; a display panel disposed behind the front cover; a base board coupled to a rear surface of the front panel and having a front surface on which the display panel is mounted; a module board coupled to a rear surface of the base board in a direction perpendicular to the base board; and one or more terminal portions electrically connected to the module board. A circuit terminal coming into contact with a connection pin of the terminal portion is formed on one side surface of a rear end portion of the module board. The rear end portion of the module board on which the circuit terminal is formed passes through a slit formed in the rear surface and protrudes to an outside of the rear surface.

### CROSS-REFERENCE TO RELATED APPLICATION

The present application claims the benefits of priority to Korean Patent Application No. 10-2022-0072670, filed on Jun. 15, 2022 which is incorporated herein by reference in their entireties.

### BACKGROUND

### 1. Field

The present disclosure relates to a temperature control apparatus that enables accurate temperature compensation by minimizing the effect of heat generated around a terminal bracket connecting a thermocouple.

### 2. Description of the Related Art

A thermocouple is a temperature measuring sensor that measures a temperature value by using thermoelectromotive force generated in proportion to a temperature difference of a junction part by bonding two different metals. The junction part is disposed at a point where temperature measurement is required, and senses the temperature of the corresponding point. A wire extending from the junction part is connected to a terminal bracket of a temperature controller, and thermoelectromotive force generated at the measurement point is transmitted to the terminal bracket.

The thermoelectromotive force transmitted to the terminal bracket is transmitted from the terminal bracket to a control board on which the terminal bracket is mounted, and the measured temperature value is finally displayed on a display panel as a numerical value.

Meanwhile, as disclosed in the prior art document below, when the wire is connected to the terminal bracket, metal materials of the terminal bracket and the wire are different from each other, and thus, thermoelectromotive force proportional to the temperature of the terminal bracket is generated. The temperature corresponding to the thermoelectromotive force sensed at the junction part is reduced by the temperature corresponding to the thermoelectromotive force generated from the terminal bracket, causing a temperature difference.

In order to compensate for the temperature difference, a separate compensation temperature sensor for measuring the temperature around the terminal bracket to which the wire is connected is disposed to sense the temperature around the terminal bracket. A temperature error is compensated for by adding the temperature sensed by the compensation temperature sensor.

Conventionally, it was technically difficult to attach the compensation temperature sensor in vicinity of the terminal bracket. Therefore, the compensation temperature sensor was attached to a specific position of the circuit board mounted inside the case of the temperature controller, and the measured temperature of the thermocouple was corrected by measuring the temperature at the attachment position.

In this case, since the compensation temperature sensor is installed at a position that is not close to the position of the terminal bracket to which the wire is connected and is spaced apart, there is a limitation in narrowing the temperature error.

In order to solve these problem, as disclosed in the prior art document, a so-called “temperature compensation module” including a compensation temperature sensor, a board on which the compensation temperature sensor is mounted, and a coupling pin extending from the board is coupled to a terminal portion to which a wire is connected so as to accurately sense the temperature around the terminal portion to which the wire is connected.

However, the prior art still suffers from the following problem. That is, since the compensation temperature sensor is located in the inner space of the case in which the circuit board is accommodated, there is a problem that the compensation temperature sensor is easily affected by heat inside the case.

Prior Art: Korean Patent Registration No. 10-1811407 (Dec. 15, 2017)

### SUMMARY

The present disclosure is proposed to solve the above problems.

In order to achieve the objects described above, a temperature control apparatus according to an embodiment of the present disclosure includes: a case comprising: an open front surface; a top surface extending from an upper end of the front surface rearward; a bottom surface extending from a lower end of the front surface rearward; left and right side surfaces extending from left and right side ends of the front surface; and a rear surface connecting rear ends of the top surface, the bottom surface, and the left and right side surfaces; a front cover shielding the front surface; a display panel disposed behind the front cover; a base board coupled to a rear surface of the front panel and having a front surface on which the display panel is mounted; a module board coupled to a rear surface of the base board in a direction perpendicular to the base board; and one or more terminal portions electrically connected to the module board, wherein a circuit terminal coming into contact with a connection pin of the terminal portion is formed on one side surface of a rear end portion of the module board, and wherein the rear end portion of the module board on which the circuit terminal is formed passes through a slit formed in the rear surface of the case and protrudes to an outside of the rear surface of the case.

According to the temperature control apparatus according to the embodiment of the present disclosure, since the compensation temperature sensor is located outside the case, the effect of heat generated inside the case may be minimized. As a result, since the temperature error is minimized, there is an advantage in that the accuracy of the temperature sensed through the thermocouple is maximized.

In addition, since the terminal bracket to which the wire of the thermocouple is connected is detachably coupled to the case, the case of the temperature control apparatus may be separated in a state where the wire is connected. Accordingly, the maintenance of the temperature control apparatus is facilitated.

In addition, since only the terminal bracket can be replaced with various types, such as a screw type, a connector type, and a push-in type, without changing the case of the temperature control apparatus, there is an advantage in that the application range of the terminal bracket is expanded.

### BRIEF DESCRIPTION OF THE DRAWINGS

FIG. 1 is a front perspective view of a temperature control apparatus according to a first embodiment of the present disclosure.

FIG. 2 is a rear perspective view of the temperature control apparatus.

FIG. 3 is an exploded perspective view of the temperature control apparatus.

FIG. 4 is a cross-sectional cutaway perspective view of the temperature control apparatus taken along line 4-4 of FIG. 2.

FIG. 5 is a cross-sectional cutaway perspective view of a case constituting the temperature control apparatus taken along line 5-5 of FIG. 3.

FIG. 6 is a partial perspective view showing the rear structure of the case.

FIG. 7 is a front perspective view of a temperature control apparatus according to a second embodiment of the present disclosure.

FIG. 8 is a rear perspective view of the temperature control apparatus.

FIG. 9 is an exploded perspective view of the temperature control apparatus.

FIG. 10 is a cross-sectional cutaway perspective view of the temperature control apparatus taken along line 10-10 of FIG. 8.

FIG. 11 is an exploded perspective view of a terminal bracket and a case.

FIG. 12 is a rear perspective view of the case constituting the temperature control apparatus according to the second embodiment.

FIG. 13 is an enlarged perspective view showing the rear surface of the terminal bracket.

FIG. 14 is a front perspective view of the terminal bracket.

FIG. 15 is a bottom perspective view of the temperature control apparatus according to the second embodiment of the present disclosure.

### DETAILED DESCRIPTION

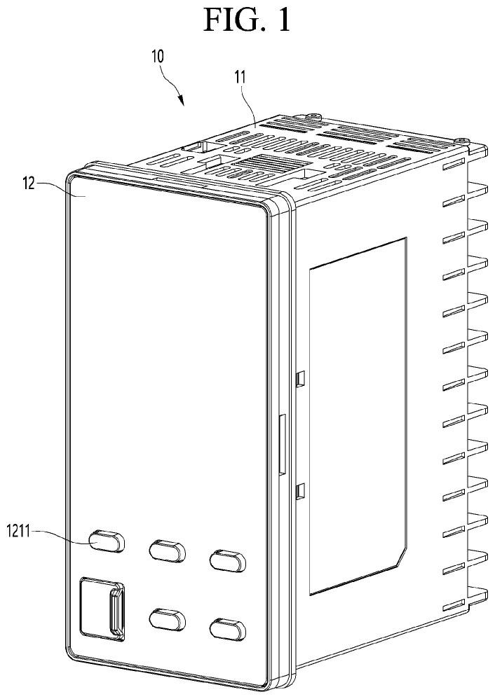

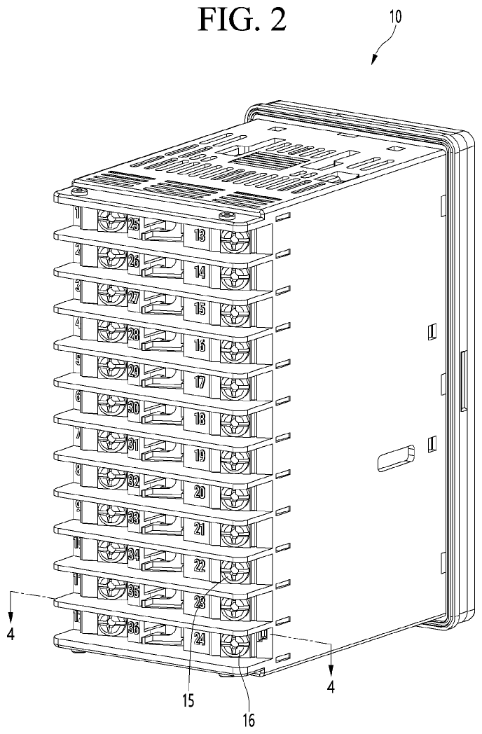

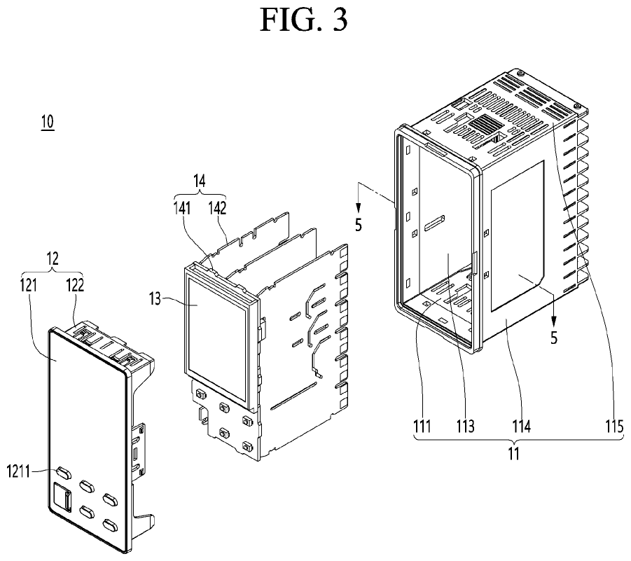

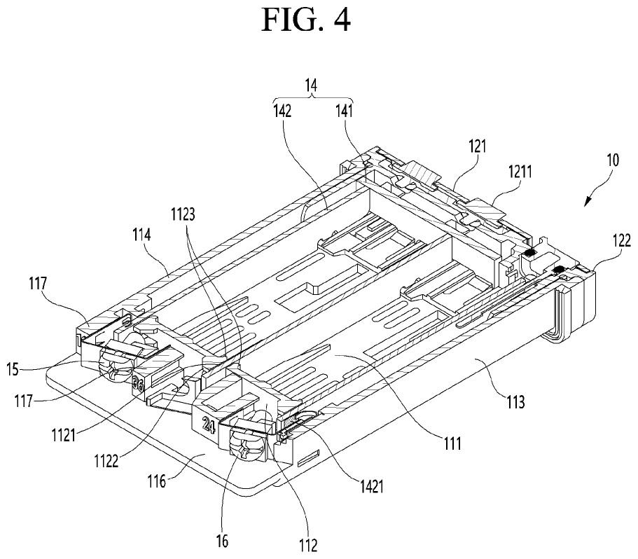

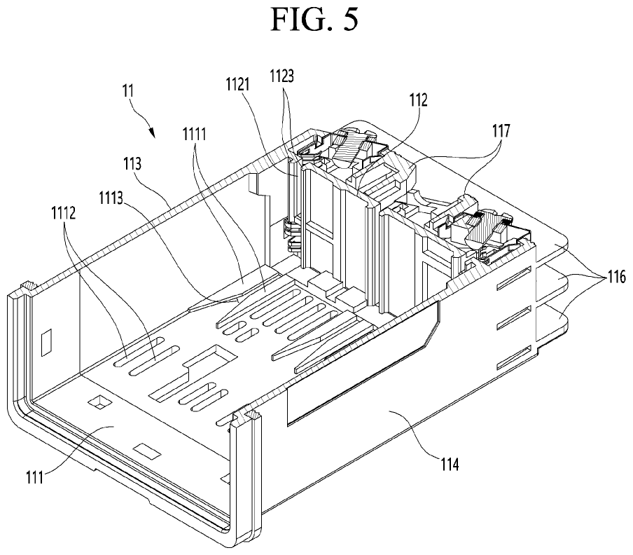

FIG. 1 is a front perspective view of a temperature control apparatus according to a first embodiment of the present disclosure, FIG. 2 is a rear perspective view of the temperature control apparatus, FIG. 3 is an exploded perspective view of the temperature control apparatus, FIG. 4 is a cross-sectional cutaway perspective view of the temperature control apparatus taken along line 4-4 of FIG. 2, and FIG. 5 is a cross-sectional cutaway perspective view of a case constituting the temperature control apparatus taken along line 5-5 of FIG. 3.

Referring to FIGS. 1 to 5, the temperature control apparatus 10 according to the first embodiment of the present disclosure includes a case 11 and a front cover 12 coupled to the open front surface of the case 11, a control board 14 coupled to the rear surface of the front cover 12 and accommodated inside the case 11, a plurality of terminal portions 15 and 16 coupled to the control board 14, and a display panel 13 mounted on the control board 14 and disposed on the rear side of the front cover 12.

In detail, the control board 14 includes a base board 141 on which the display panel 13 is mounted on the front surface, and a module board 142 coupled to the rear surface of the base board 141. The plurality of terminal portions 15 and 16 are coupled to the rear end of the module board 142. The plurality of terminal portions 15 and 16 are vertically spaced apart from the rear end of the module board 142.

A plurality of module board 142 may be provided. The plurality of module board 142 may be erected in a direction perpendicular to the base board 141 and spaced apart from each other by a predetermined interval in a width direction (or a left-and-right direction) of the base board 141. A circuit terminal 1421 contacting connection pins of the terminal portions 15 and 16 is provided on one of two side surfaces of the rear end portion of the module board 142.

One or more button switches may be mounted on the front surface of the base board 141 corresponding to the lower side of the display panel 13.

In addition, the front cover 12 may include a cover frame 122, a window 121 mounted on the front surface of the cover frame 122, and one or more input buttons 1211 penetrating the window 121 and contacting the button switch.

Meanwhile, the case 11 may have a hexahedral shape with an empty interior. In detail, the case 11 includes a bottom surface 111, a rear surface 112, a right surface 113, a left surface 114, a top surface 115, and a front surface, and the front surface of the case 11 is shielded by the front cover 12. The front cover 12 is detachably coupled to the front surface in order to repair or replace parts accommodated inside the case 11.

In detail, slits 1121 through which the end portion of the module board 142 passes are vertically formed on the rear surface 112 of the case 111, and the number of slits 1121 corresponds to the number of module boards 142.

A partition rib 116 extends from the rear surface 112 of the case 11. The partition rib 116 extends horizontally in the width direction of the case 11, that is, in a direction connecting the left surface 114 and the right surface 113 to each other. A plurality of partition ribs 116 are provided. The plurality of partition ribs 116 are spaced apart from each other by predetermined intervals in the height direction of the case 11, that is, in a direction from the bottom surface 111 to the top surface 115. A support portion 117 supporting the terminal portions 15 and 16 is formed between the partition ribs 116 adjacent to each other.

A plurality of heat dissipation holes 1112 are formed in the bottom surface 111 of the case 11 so that heat generated inside the case 11 is discharged to the outside.

In addition, an insertion guide 1111 is formed on the bottom surface 111 to guide insertion of the module board 142 into the slit 1121. In detail, the insertion guide 1111 is formed at a point on the bottom surface 111 corresponding to the front side of the slit 1121 and may be understood as a step or a protrusion protruding upward from the bottom surface 111.

Aboard insertion hole 1113 for guiding insertion of the module board 142 is formed in the insertion guide 1111, and the board insertion hole 1113 may be understood as a groove in which a portion of the insertion guide 1111 is cut in a Y-shape.

The board insertion hole 1113 includes a tapered portion extending in a direction in which the width decreases from the front end of the insertion guide 1111 toward the rear side, a straight portion extending from the rear end of the tapered portion to the rear end of the insertion guide 1111 in a straight line form.

The tapered portion has a triangular groove that is inclined in a form in which the width becomes narrower toward the straight portion. Therefore, even when the module board 142 is not aligned on the same line as the straight portion and moves toward the slit 1121 at a point that is shifted from the straight portion in the width direction of the case 11, the module board 142 is guided along the inclined surface of the tapered portion, and finally, the rear end of the module board 142 is inserted into the second portion.

The straight portion may be formed to have a width corresponding to the thickness of the module board 142. The straight portion may be formed to have a width corresponding to the width of the slit 1121. When the straight portion and the slit 1121 are aligned on the same vertical plane and the module board 142 slides toward the rear surface 112 in a state of being inserted into the straight portion, the rear end of the module board 142 is accurately inserted into the slit 1121 without interfering with the edge portion of the slit 1121.

The rear end of the module board 142 passes through the slit 1121 and protrudes toward the outside of the case 11, and the circuit terminal 1421 is formed on one side of the rear end portion of the module board 142 protruding toward the outside of the case 11.

In addition, a pair of guide ribs 1123 may protrude from left and right edges of the slit 1121. The pair of guide ribs 1123 extend from the edge of the slit 1121 and protrude from the inner surface of the rear surface 112 defining the inner space of the case 11. A space formed between the pair of guide ribs 1123 has the same cross-sectional shape as the board insertion hole 1113 formed inside the insertion guide 1111 and may guide insertion of the module board 142.

In addition, a board support rib 1122 may protrude from one of the left and right edges of the slit 1121 corresponding to the outer surface of the rear surface 112. The board support rib 1122 is a rib extending horizontally, and a plurality of board support ribs 1122 may be spaced apart from each other in the vertical direction of the case 11.

The one or more board support ribs 1122 support a second surface of the module board 142 corresponding to a surface opposite to the first surface on which the circuit terminal 1421 is formed. The board support rib 1122 provides reaction force against pressing force acting on the module board 142 by a connection pin (to be described below) coming in contact with the circuit terminal 1421, and prevents bending when the terminal portions 15 and 16 are coupled to the end portion of the module board 142.

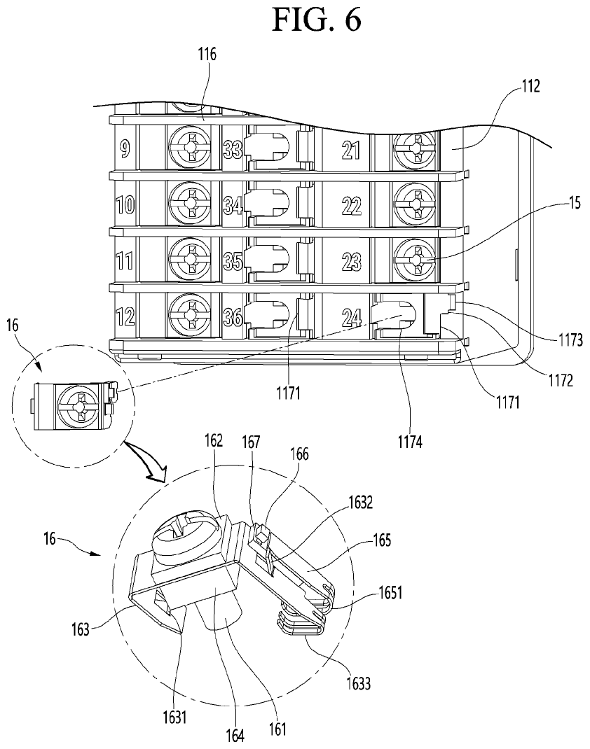

FIG. 6 is a partial perspective view showing the rear structure of the case.

Referring to FIG. 6, a terminal support portion 117 supporting one or more terminal portions 15 and 16 is formed on the rear surface 112 of the case 11.

In detail, the terminal support portion 117 protrudes from the outer surface of the rear surface 112 and supports the terminal portions 15 and 16.

The end portion of the module board 142 passing through the slit 1121 is located in a so-called “intermediate space” defined by the terminal support portion 117 and the rear surface 112. In other words, the circuit terminal 1421 is located in the intermediate space out of the inner space of the case 11. Accordingly, the portion of the circuit terminal 1421 is hardly affected by heat generated in the inner space of the case 11.

The terminal portion includes a temperature compensation terminal portion 16 with a compensation temperature sensor and a general terminal portion 15 (or a basic terminal portion) without a compensation temperature sensor. One temperature compensation terminal portion 16 may form a set with one or more general terminal portions 15.

The temperature compensation terminal portion 16 includes a main coupling pin 163 bent in a ‘1=’ shape, a bolt 161 passing through the main coupling pin 163, a washer 162 provided between the main coupling pin 163 and the head of the bolt 161, a nut 164 fitted to the bolt 161 on the opposite side of the washer 162, and a temperature compensation module mounted on the main coupling pin 163.

The main coupling pin 163 includes a first portion through which the bolt 161 passes, a second portion bent at one end of the first portion, and a third portion bent at the other end of the first portion.

A first locking protrusion 1631 and a second locking protrusion 1632 are respectively formed on the first portion and the third portion. The first and second locking protrusions 1631 and 1632 are caught on the terminal support portion 117 to prevent the main coupling pin 163 from being separated from the terminal support portion 117.

The end portion of the wire extending from the thermocouple is inserted between the washer 162 and the first portion and electrically connected to the temperature compensation terminal portion 16.

In addition, a main connection pin 1633 is formed at the end portion of the third portion, and the main connection pin 1633 comes into contact with the circuit terminal 1421. The main connection pin 1633 is formed by bending the end portion of the third portion.

In addition, the temperature compensation module includes a sensor board 167 attached to the third portion, a compensation temperature sensor 166 mounted on the sensor board 167, and a sub-coupling pin 165 attached to the sensor board 167. A sub-connection pin 1651 is formed at the end portion of the sub-coupling pin 165 and comes into contact with the circuit terminal 1421. The sub-connection pin 1651 is formed by bending the end portion of the sub-coupling pin 165.

Since specific functions and operations of the temperature compensation terminal portion 16 are substantially the same as those disclosed in the prior art, additional description thereof is omitted.

However, unlike the temperature compensation terminal portion disclosed in the prior art, when the temperature compensation terminal portion 16 according to the present disclosure is coupled to the rear end of the module board 142, the compensation temperature sensor 166 is exposed to the outside of the case 11 as shown in FIG. 4. In detail, the circuit terminal 1421 coming into contact with the connection pins 1633 and 1651 is located in the intermediate space defined by the terminal support portion 117, and the compensation temperature sensor 166 is exposed to the outside of the intermediate space. Therefore, since the compensation temperature sensor 166 is isolated from the inner space of the case 11, the compensation temperature sensor 166 may accurately measure the temperature around the temperature compensation terminal portion 16.

The terminal support portion 117 includes a bolt insertion hole 1174 through which the bolt 161 passes, a first opening formed at a portion where the general terminal portion 17 is mounted, and a second opening formed at a portion where the temperature compensation terminal portion 16 is mounted.

The first opening is a pin insertion hole 1171 having a size through which the coupling pin of the general terminal portion 17 passes. A pin insertion hole 1171 through which the main coupling pin 163 passes, a board accommodation hole 1172 through which the sub-coupling pin 165 and the sensor board 167 pass, and a sensor accommodation port 1173 in which the compensation temperature sensor 166 is accommodated are formed in the second opening.

In detail, in order to prevent the main coupling pin 163 and the temperature compensation module from interfering with the rear surface of the case 11, the second opening is formed to be larger than the first opening.

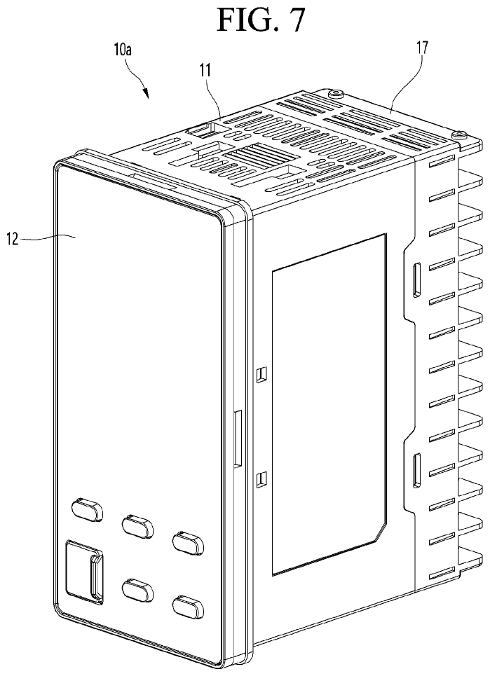

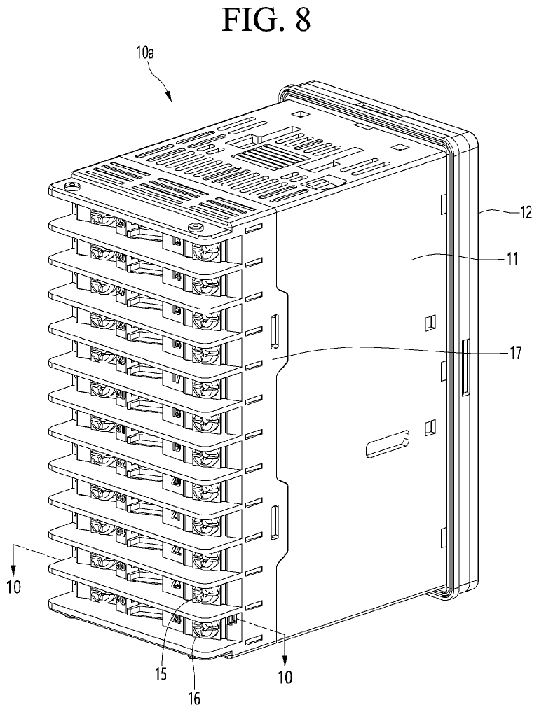

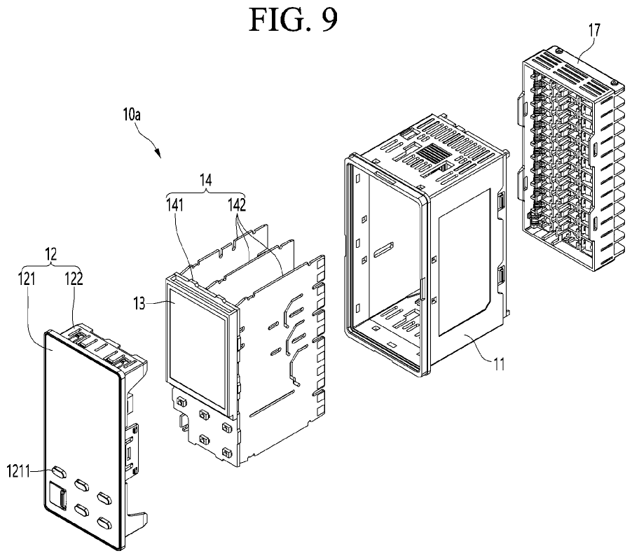

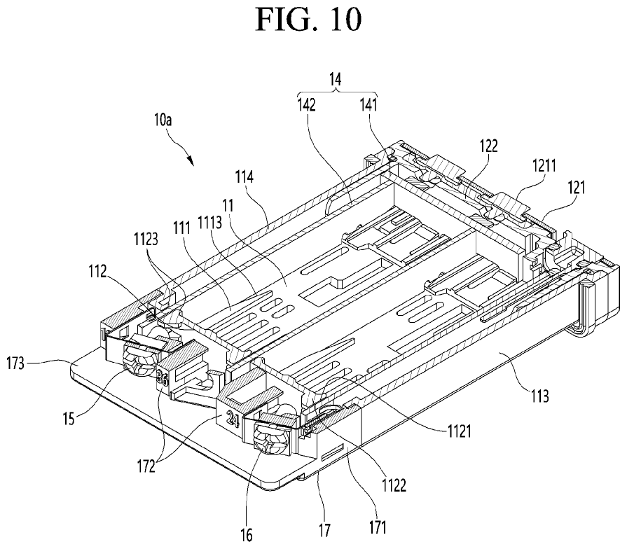

FIG. 7 is a front perspective view of a temperature control apparatus according to a second embodiment of the present disclosure, FIG. 8 is a rear perspective view of the temperature control apparatus, FIG. 9 is an exploded perspective view of the temperature control apparatus, and FIG. 10 is a cross-sectional cutaway perspective view of the temperature control apparatus taken along line 10-10 of FIG. 8.

Referring to FIGS. 7 to 10, like the temperature control apparatus 10 according to the first embodiment, the temperature control apparatus 10a according to the second embodiment of the present disclosure includes a front cover 12, a display panel 13, a circuit board 14, a case 11, and terminal portions 15 and 16.

However, the temperature control apparatus 10a according to the present embodiment differs from the temperature control apparatus 10 according to the first embodiment in that the terminal support portion on which the terminal portions 15 and 16 are mounted is provided as a separate member so as to be separable from the case 11.

In detail, the temperature control apparatus 10a according to the present embodiment further includes a terminal bracket 17 detachably coupled to the rear surface of the case 11 and having a terminal support portion 172 formed thereon.

Hereinafter, the rear structure of the case 11 and the structure of the terminal bracket 17 will be described in detail with reference to the drawings. The same reference numerals are assigned to components identical to those of the temperature control apparatus 10 according to the previous embodiment, and redundant descriptions thereof are omitted.

According to the present embodiment, the terminal bracket 17 includes a terminal support portion 172 to which the terminal portions 15 and 16 are coupled, and a plurality of partition ribs 173 partitioning the terminal portions 15 and 16 up and down. This corresponds to a difference from the previous embodiment in which the terminal support portion 172 and the partition rib 173 are part of the case 11.

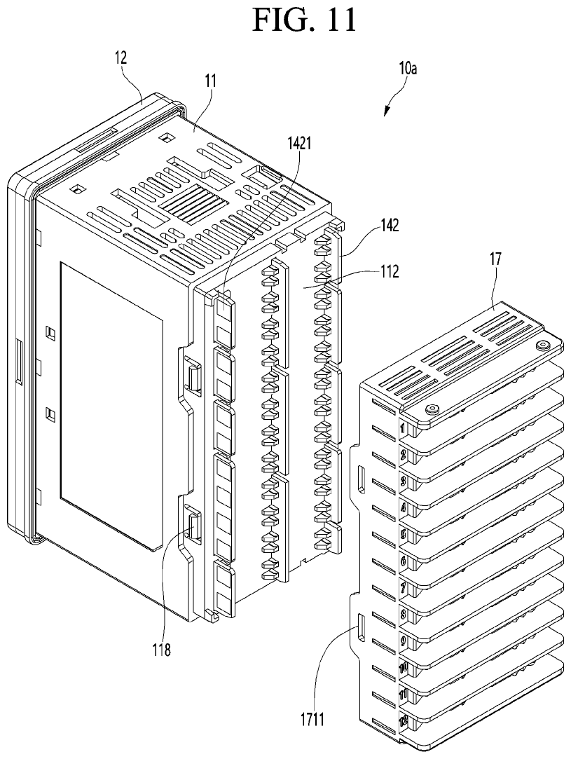

FIG. 11 is an exploded perspective view of the terminal bracket and the case.

Referring to FIG. 11, the terminal bracket 17 is detachably coupled to the rear surface of the case 11.

In detail, a catching hook may protrude from one side of the terminal bracket 17 and the case 11, and a hook hole for catching the catching hook may be formed on the other side of the terminal bracket 17 and the case 11.

In the present embodiment, an example in which one or more hooks 118 protrude from the rear ends of two sides of the case 11 and one or more hook holes 1711 are formed at the front ends of two sides of the terminal bracket 17 will be described.

However, it should be noted that the fastening structure of the terminal bracket 17 and the case 11 is not limited to the hook and hook hole structure, and any detachable fastening structure is applicable.

The rear end portion of the module board 142, that is, the portion where the circuit terminal 1421 is formed passes through the rear surface of the case 11 and is exposed to the outside. The exposed portion of the circuit terminal 1421 is accommodated in the intermediate space formed by coupling the terminal bracket 17 to the rear surface of the case 11, which is the same as in the previous embodiment.

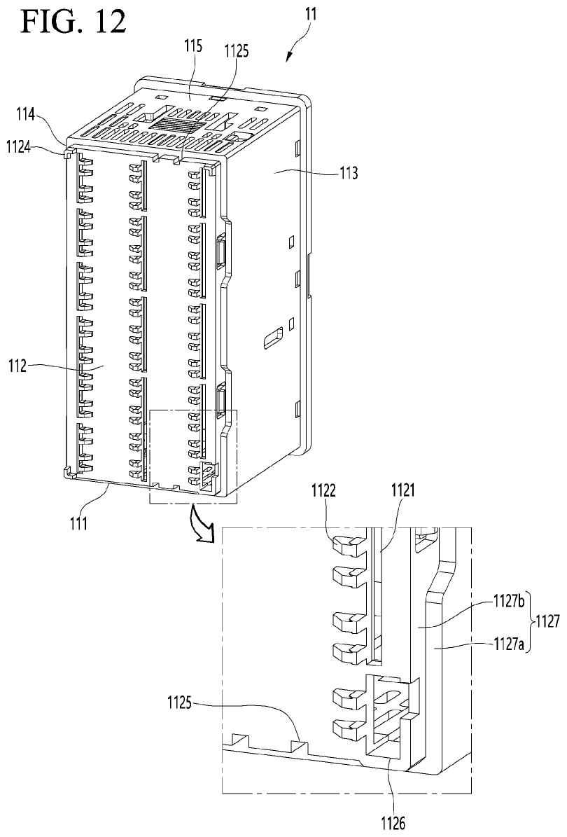

FIG. 12 is a rear perspective view of the case constituting the temperature control apparatus according to the second embodiment.

Referring to FIG. 12, as in the previous embodiment, a slit 1121 and a board support rib 1122 are formed on the rear surface 112 of the case 11.

In detail, only an opening defined by the slit 1121 through which the rear end of the module board 142 passes is formed at a portion where the general terminal unit 15 is mounted, and an opening 1126 that is larger than the slit 1121 is formed at a portion where the temperature compensation terminal unit 16 is mounted. This is for accommodating the sensor board 167 and the sub-coupling pin 165 constituting the temperature compensation module. The opening 1126 that is larger than the slit 1121 is formed in the same manner on the rear surface of the case 11 according to the first embodiment.

Meanwhile, a terminal bracket seating shoulder 1127 on which the front end portion of the terminal bracket 17 is seated is formed at the rear edge of the case 11. The terminal bracket seating shoulder 1127 includes a seating surface 1127a on which the front end portion of the terminal bracket 17 is disposed and a support surface 1127b closely supporting the side surface of the terminal bracket 17. The catching hook 118 may protrude from the support surface 1127b.

In addition, mounting guide protrusions 1124 protrude from one or more points among four corners of the rear surface 112 of the case 11 and may guide the terminal bracket 17 to be coupled to the correct position without shaking.

The one or more mounting guide protrusions 1124 may protrude from at least some of the four corners defined by the terminal bracket mounting protrusion 1127 and may be bent in an L shape. The shape of the mounting guide protrusion 1124 is not limited to the suggested shape.

In addition, reverse coupling prevention grooves 1125 may be formed on two surfaces facing each other among four support surfaces 1127b. The reverse coupling prevention grooves 1125 may be formed at positions spaced from a vertical plane or a vertical line that bisects the rear surface 112 to the left and right toward the left or right edge of the rear surface 112.

In the present embodiment, it is proposed that the reverse coupling prevention grooves 1125 are formed on the support surfaces 1127b defining the upper and lower edges of the rear surface 112, respectively. One or more reverse coupling prevention grooves 1125 may be spaced apart from each other on the two support surfaces 1127b facing each other.

As another example, the reverse coupling prevention grooves 1125 are formed on the left and right edges of the rear surface 112, and may be formed at positions spaced apart toward the upper or lower edge of the rear surface 112 with respect to the horizontal plane or the horizontal line that bisects the rear surface 112 vertically.

As described above, since the reverse coupling prevention grooves 1125 are formed at positions shifted from the vertical or the horizontal plane passing through the center of the rear surface 112 toward the edge of the rear surface 112, the coupling is impossible if the top and bottom surfaces of the terminal bracket 17 are turned upside down and coupled to each other, thereby enabling correct assembly of the terminal bracket 17.

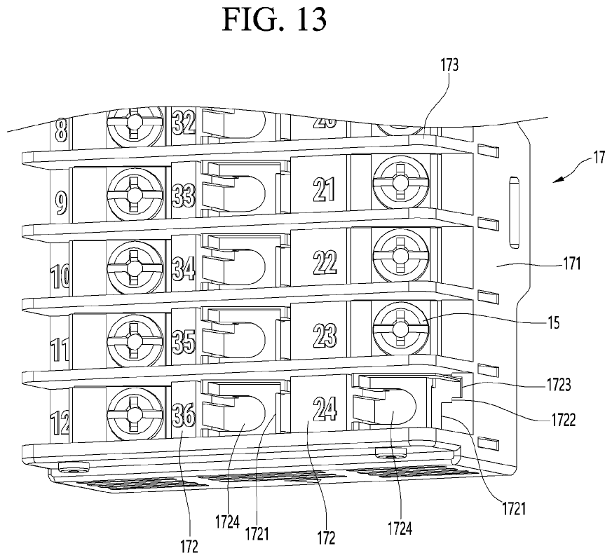

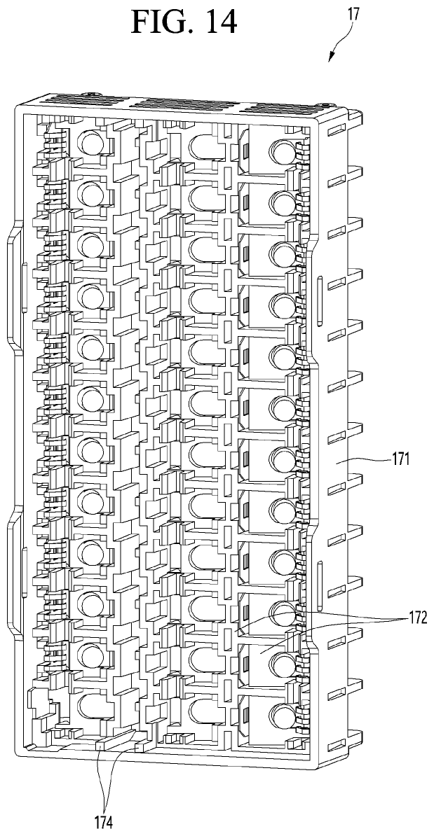

FIG. 13 is an enlarged perspective view showing the rear surface of the terminal bracket, and FIG. 14 is a front perspective view of the terminal bracket.

Referring to FIGS. 13 and 14, the terminal bracket 17 includes a frame 171, a plurality of partition ribs 173 extending horizontally to connect the rear end portion of the left side and the rear side portion of the right side of the frame 171, and a terminal support portion 172 formed between the partition ribs 173 adjacent to each other.

In detail, the front end of the frame 171 is disposed on the seating surface 1127a, and the inner side surface of the frame 171 is in close contact with the support surface 1127b.

In addition, the hook hole 1711 may be formed on the outer side surface of the frame 171.

Here, the frame 171 is a part of the terminal support portion 172 and may also be understood as an edge portion of the terminal support portion 172.

As in the previous embodiment, a bolt insertion hole 1724, a pin insertion hole 1721, a board accommodation hole 1722, and a sensor accommodation hole 1723 may be formed in the terminal support portion 172, and redundant descriptions thereof are omitted.

Here, the opening 1126 formed in the rear surface of the case 11 is defined as a first opening, and one large opening formed by connecting the pin insertion hole 1721, the board accommodation hole 1722, and the sensor accommodation hole 1723 may be defined as a second opening. The second opening is located right behind the first opening.

Similarly, the first opening is formed in the rear surface 112 of the case 11 according to the first embodiment, and the second opening is formed at a portion of the terminal support portion 117 right behind the rear of the first opening. Due to this structure, the connection pins 1633 and 1651 of the temperature compensation terminal unit 16 may stably come into contact with the circuit terminal 1421 through the first and second openings, without interfering with the rear surface 112 of the case 11 and the terminal support portion 117.

In addition, one or more reverse coupling prevention protrusions 174 fitted to the reverse coupling prevention grooves 1125 protrude from the top and bottom surfaces of the frame 171. Therefore, when the terminal bracket 17 is properly coupled to the rear surface of the case 11, the reverse coupling prevention protrusion 174 is inserted into the reverse coupling prevention groove 1125. However, coupling is not achieved when the top and bottom surfaces of the terminal bracket 17 are reversed and brought into close contact with the rear surface of the case 11.

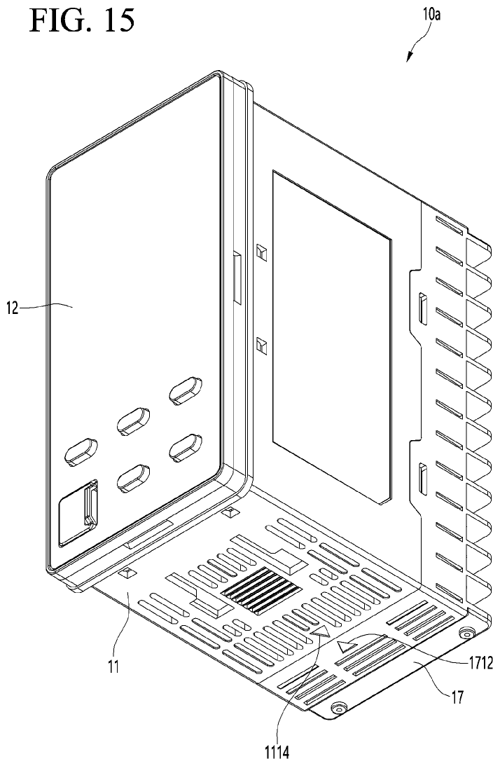

FIG. 15 is a bottom perspective view of the temperature control apparatus according to the second embodiment of the present disclosure.

Referring to FIG. 15, coupling direction notifying portions 1114 and 1712 may be formed on the bottom surface of the case 11 and the bottom surface of the terminal bracket 17.

In detail, when the terminal bracket 17 is completely coupled to the rear surface of the case 11, the two coupling direction notifying portions 1114 and 1712 are aligned on the same line at positions facing each other.

The coupling direction notifying portions 1114 and 1712 may be formed in various shapes including triangles and may be formed on at least one of top and bottom surfaces and left and right surfaces of the case 11 and the terminal bracket 17.

As described above, since various configurations for preventing misassembly of the terminal bracket 17 are formed in the case 11 and the terminal bracket 17, there is an advantage in that it is possible to reliably prevent a phenomenon in which the terminal bracket 17 is coupled to the rear surface of the case 11 in a state where the vertical positions of the terminal bracket 17 are reversed.

In addition, since the terminal bracket 17 to which the terminal portions 15 and 16 are coupled may be separated from the case 11, there is an advantage in that the case 11 may be separated without the need to separate conducting wires and signal lines connected to the terminal portions 15 and 16 from the terminal portions 15 and 16 in a state where the temperature control apparatus 10 is fixed to an installation position.

In other words, only the case 11 is separated from the terminal bracket 17 without separating the terminal bracket 17 in a state where the conducting wires and signal lines are connected to the terminal portions 15 and 16. Accordingly, there is an advantage that can repair and replace various parts accommodated inside the case 11.

In addition, since only the terminal bracket 17 can be replaced with various types such as screw type, connector type, and push-in type, without changing the case 11 of the temperature control apparatus, there is an advantage that the application range of the terminal bracket 17 is expanded.

The temperature control apparatus according to the first and second embodiments of the present disclosure described above can be summarized as having the following features.

Specifically, the temperature control apparatus according to an embodiment of the present disclosure includes; a case including an open front surface, a top surface extending from an upper end of the front surface toward a rear side, a bottom surface extending from a lower end of the front surface toward the rear side, left and right side surfaces extending from left and right side ends of the front surface, and a rear surface connecting rear ends of the top surface, the bottom surface, and the left and right side surfaces; a front cover shielding the front surface; a display panel disposed behind the front cover; a base board coupled to a rear surface of the front panel and having a front surface on which the display panel is mounted; a module board coupled to a rear surface of the base board in a direction perpendicular to the base board; and one or more terminal portions electrically connected to the module board, wherein a circuit terminal coming into contact with a connection pin of the terminal portion is formed on one side surface of a rear end portion of the module board, and the rear end portion of the module board on which the circuit terminal is formed passes through a slit formed in the rear surface and protrudes to an outside of the rear surface.

The case further includes a plurality of partition ribs extending from the rear surface and spaced apart from each other at predetermined intervals, and a terminal support portion formed between two adjacent partition ribs and the rear surface to support the terminal portion from the outside of the rear surface.

The rear end portion of the module board at which the circuit terminal is formed is disposed in an intermediate space formed between the rear surface and the terminal support portion.

The terminal portion includes: a main coupling pin provided with a main connection pin coming into contact with the circuit terminal; a bolt passing through the main coupling pin; a nut fitted to the bolt; and a temperature compensation module mounted on the main coupling pin.

A first opening that is larger than the slit may be formed on the rear surface in order to accommodate the rear end portion of the module board and at least a portion of the temperature compensation module.

The temperature compensation module includes: a sensor board having a bottom surface coupled to the main coupling pin; a compensation temperature sensor mounted on one side of a top surface of the sensor board; and a sub-coupling pin attached to the other side of the top surface of the sensor board corresponding to the lower side of the compensation temperature sensor and provided with a sub-connection pin coming into contact with the circuit terminal.

A second opening accommodating the main coupling pin and at least a portion of the temperature compensation module is formed in the terminal support portion, and the second opening is positioned right behind the first opening.

The case includes an insertion guide protruding upward from the bottom surface in order to guide insertion of the rear end of the module board into the slit.

A board insertion hole is formed inside the insertion guide. The board insertion hole includes a tapered portion extending in a direction in which the width decreases from the front end of the insertion guide toward the rear side, and a straight portion extending from the rear end of the tapered portion to the rear end of the insertion guide in a straight line form.

The straight portion and the slit are aligned on the same vertical plane.

The case further includes a guide rib protruding from an inner surface of the rear surface corresponding to an edge of the slit to guide insertion of the rear end portion of the module board.

The temperature control apparatus according to the present disclosure further includes a board support rib protruding from an outer surface of the rear surface corresponding to the edge of the slit to support the module board.

A plurality of board support ribs are provided to be spaced apart from each other in the vertical direction.

A portion including the terminal support portion and the partition rib is defined as a terminal bracket, and the terminal bracket is detachable from the rear surface of the case.

A terminal bracket seating shoulder on which the front edge of the terminal bracket is seated is formed at the edge of the rear surface.

The terminal bracket seating shoulder includes a seating surface on which the front surface of the terminal bracket is disposed and a contact surface coming into close contact with an inner circumferential surface of the terminal bracket, and the seating surface and the contact surface are surfaces crossing each other.

The temperature control apparatus according to the present disclosure further includes a reverse coupling prevention means for preventing the terminal bracket from being coupled to the rear surface of the casein a state where the vertical positions of the terminal bracket are reversed. The reverse coupling preventing means is formed at a position spaced apart from a vertical plane or a horizontal plane that bisects the case.

The reverse coupling prevention means includes a reverse coupling prevention groove recessed in the seating surface and a reverse coupling prevention protrusion protruding from the inner circumferential surface of the terminal bracket and inserted into the reverse coupling prevention groove.

The temperature control apparatus according to the present disclosure further includes at least one mounting guide protrusion protruding from the rear surface.

The at least one mounting guide protrusion is formed at a corner portion defined by the seating surface.

The temperature control apparatus according to the present disclosure further includes a fastening portion for detachably coupling the terminal bracket to the case.

The fastening portion includes a fastening hook provided on one side of the case and the terminal bracket, and a hook hole provided on the other side of the case and the terminal bracket to catch the fastening hook.

The temperature control apparatus according to the present disclosure further includes coupling direction notifying portions formed on an outer circumferential surface of the case and an outer circumferential surface of the terminal bracket.

The coupling direction notifying portions are located at positions facing each other when the terminal bracket is coupled to the rear surface of the case.

What is claimed is:

1. A temperature control apparatus comprising:
a case comprising:
an open front surface;
a top surface extending from an upper end of the front surface rearward;
a bottom surface extending from a lower end of the front surface rearward;
left and right side surfaces extending from left and right side ends of the front surface; and
a rear surface connecting rear ends of the top surface, the bottom surface, and the left and right side surfaces;
a front cover shielding the front surface;
a display panel disposed behind the front cover;
a base board coupled to a rear surface of the front panel and having a front surface on which the display panel is mounted;
a module board coupled to a rear surface of the base board in a direction perpendicular to the base board; and
one or more terminal portions electrically connected to the module board,
wherein a circuit terminal coming into contact with a connection pin of the terminal portion is formed on one side surface of a rear end portion of the module board,
and wherein the rear end portion of the module board on which the circuit terminal is formed passes through a slit formed in the rear surface of the case and protrudes to an outside of the rear surface of the case.

2. The temperature control apparatus of claim 1, wherein the case further comprises:
a plurality of partition ribs extending from the rear surface and spaced apart from each other at predetermined intervals; and
a terminal support portion formed between two adjacent partition ribs and supporting the terminal portion from an outside of the rear surface,
wherein the rear end portion of the module board at which the circuit terminal is formed is disposed in an intermediate space formed between the rear surface and the terminal support portion.

3. The temperature control apparatus of claim 2, wherein the terminal portion comprises:
a main coupling pin provided with a main connection pin coming into contact with the circuit terminal;
a bolt passing through the main coupling pin;
a nut fitted to the bolt; and
a temperature compensation module mounted on the main coupling pin,
wherein a first opening that is larger than the slit is formed on the rear surface of the case, in order to accommodate the rear end portion of the module board and at least a portion of the temperature compensation module.

4. The temperature control apparatus of claim 3, wherein the temperature compensation module comprises:
a sensor board having a bottom surface coupled to the main coupling pin;
a compensation temperature sensor mounted on one side of a top surface of the sensor board; and
a sub-coupling pin attached to the other side of the top surface of the sensor board corresponding to a lower side of the compensation temperature sensor and having a sub-connection pin coming into contact with the circuit terminal.

5. The temperature control apparatus of claim 4, wherein a second opening accommodating the main coupling pin and at least a portion of the temperature compensation module is formed in the terminal support portion,
wherein the second opening is located right behind the first opening.

6. The temperature control apparatus of claim 1, wherein the case comprises an insertion guide protruding upward from the bottom surface.

7. The temperature control apparatus of claim 6, wherein a board insertion hole is formed inside the insertion guide,
wherein the board insertion hole comprises:
a tapered portion extending in a direction in which a width decreases from a front end of the insertion guide toward a rear side; and
a straight portion extending from a rear end of the tapered portion to a rear end of the insertion guide in a straight line form,
wherein the straight portion and the slit are aligned on a same vertical plane.

8. The temperature control apparatus of claim 1, wherein the case further comprises a guide rib protruding from an inner surface of the rear surface of the case corresponding to an edge of the slit.

9. The temperature control apparatus of claim 1, further comprising a board support rib protruding from an outer surface of the rear surface of the case corresponding to an edge of the slit and supporting the module board.

10. The temperature control apparatus of claim 9, wherein the board support rib is provided in plurality, and the plurality of board support ribs are provided to be spaced apart from each other in a vertical direction.

11. A temperature control apparatus comprising:
a case having a rear surface with a slit formed therein;
a front cover on a front surface of the case;
a base board between the rear surface and the front cover;
a display panel mounted on the base board and positioned between the front cover and the base board;
a module board coupled to the base board and having a rear end portion exposed to an outside of the case through the slit; and
a terminal bracket coupled to the rear surface of the case and having a plurality of terminal portions electrically connected to the module board,
wherein the module board comprises a circuit terminal formed at the rear end portion,
wherein the case comprises a board support rib protruding from the rear surface of the case.

12. The temperature control apparatus of claim 11, wherein a terminal bracket seating shoulder on which a front edge of the terminal bracket is seated is formed at an edge of the rear surface.

13. The temperature control apparatus of claim 12, wherein the terminal bracket seating shoulder comprises:
a seating surface on which a front surface of the terminal bracket is disposed; and
a contact surface with which an inner circumferential surface of the terminal bracket comes into contact,
wherein the seating surface and the contact surface are surfaces crossing each other.

14. The temperature control apparatus of claim 13, further comprising a reverse coupling prevention means on the rear surface of the case,
wherein the reverse coupling prevention means is formed at a position spaced apart from a vertical plane or a horizontal plane that bisects the case.

15. The temperature control apparatus of claim 14, wherein the reverse coupling prevention means comprises:
a reverse coupling prevention groove recessed in the seating surface; and
a reverse coupling prevention protrusion protruding from the inner circumferential surface of the terminal bracket and inserted into the reverse coupling prevention groove.

16. The temperature control apparatus of claim 13, further comprising at least one mounting guide protrusion protruding from the rear surface of the case,
wherein the at least one mounting guide protrusion is formed at a corner portion defined by the seating surface.

17. The temperature control apparatus of claim 11, further comprising a fastening portion detachably coupling the terminal bracket to the case,
wherein the fastening portion comprises:
a catching hook provided on one side of the case and the terminal bracket; and
a hook hole provided on the other side of the case and the terminal bracket and catching the catching hook.

18. The temperature control apparatus of claim 11, further comprising coupling direction notifying portions formed on an outer circumferential surface of the case and an outer circumferential surface of the terminal bracket,
wherein the coupling direction notifying portions are located at positions facing each other when the terminal bracket is coupled to the rear surface of the case.

19. The temperature control apparatus of claim 11, wherein the case comprises a guide rib protruding from the rear surface toward the front cover,
wherein the guide rib is adjacent to the slit.

20. The temperature control apparatus of claim 11, wherein the terminal bracket comprises a plurality of partition ribs,
wherein the terminal portions are located between two partition ribs adjacent to each other among the plurality of partition ribs.
